(19) United States
(12) Patent Application Publication
(10) Pub. No.: US 2006/0287543 A1
(43) Pub. Date: Dec. 21, 2006

(54) Process for purification and decolorization of 2-hydroxy-4-(methylthio)butanoic acid (HMTBA)-containing complexes

(75) Inventors: Michael L. Trehy, Saint Louis, MO (US); Thomas F. Blackburn, Chesterfield, MO (US); John A. Hume, Lake St. Louis, MO (US); Charles S. Schasteen, St. Louis, MO (US)

Correspondence Address: PALMER & DODGE, LLP;KATHLEEN M. WILLIAMS, 111 HUNTINGTON AVENUE, BOSTON, MA, 02199, US

(73) Assignee: Novus International, Inc.

(21) Appl. No.: 11/413,529

(22) Filed: Apr. 28, 2006

Related U.S. Application Data
(60) Provisional application No. 60/676,589, filed on Apr. 29, 2005.

(51) Int. Cl. C07F 3/02; C07F 3/08

(52) U.S. Cl. 556/131; 562/512

(57) ABSTRACT

Disclosed herein are processes for purifying a complex of 2-hydroxy-4-(methylthio)butanoic acid and a cation. The complex purified using the disclosed methods are substantially free of discoloration and can be suitable, for example, as a source of methionine and minerals for animals, including humans, companion animals and agricultural animals.

This application claims the benefit of U.S. Provisional Application Ser. No. 60/676,589, filed Apr. 29, 2005, which is hereby incorporated by reference in its entirety.

### FIELD OF THE INVENTION

This invention relates to a process for purifying 2-hydroxy-4-(methylthio)butanoic acid and 2-hydroxy-4-(methylthio)butanoic acid complexes. The purified 2-hydroxy-4-(methylthio)butanoic acid and complexes thereof can serve as useful sources of methionine and complexed minerals.

### BACKGROUND OF THE INVENTION

Complexed minerals are the preferred source of essential dietary minerals. Complexation of minerals through, for example, formation of a coordination complex has been shown to enhance absorption of the mineral into the body, either by directly enhancing absorption or reducing the amount that is lost due to absorption by bacteria residing within the digestive system. Compounds that are typically used as electron donors to form such complexes include amino acids, the use of which has the additional benefit of providing, in many cases, a source of essential amino acids. The methionine analog 2-hydroxy-4-(methylthio)butanoic acid (HMTBA) has long been used as a nutrient supplement for ruminants and poultry. In animals, HMTBA has been demonstrated to be as effective as methionine, an essential amino acid, for nutritional purposes, with favorable absorption profiles. Furthermore, HMTBA is less expensive and easier to produce. HMTBA has been shown to be more effective than methionine in situations. For example, it is beneficial when the presence of a primary amino function is deleterious, as in its use in uremic patients wherein they are on protein dietary restriction to improve nitrogen balance, yet need the nitrogen-free analogs of essential amino acids, e.g., in humans (methionine, valine, leucine and isoleucine) to maintain proper nutrition (Mitch & Walser, (1977) Clinical Nephrology 8(2) pp 341-344). Complexes of HMTBA and minerals have been described. For example, U.S. Pat. No. 4,335,257 and U.S. Pat. No. 4,855,495 describe calcium HMTBA complexes. U.S. Pat. No. 6,461,664 describes complexes of HMTBA with numerous divalent metals.

### SUMMARY OF THE INVENTION

The present invention is based on the surprising discovery that colored solutions of HMTBA complexes can be purified and decolored by treatment with activated carbon. The present invention is also based on the discovery that precipitation of 2-hydroxy-4-(methylthio)butanoic acid in an approximately 10% solution is delayed, allowing for removal of powdered carbon prior to precipitation of the white product. This approach minimizes material handling and use of solvents and generates virtually colorless high-purity 2-hydroxy-4-(methylthio)butanoic acid. The processes of the present invention yields purified 2-hydroxy-4-(methylthio)butanoic acid complexes which are suitable for many uses, for example, as nutritional supplements for mammals, including humans.

In a first aspect, the present invention provides for a process for purifying a 2-hydroxy-4-(methylthio)butanoic acid complex comprising the following steps:
(a) providing a 2-hydroxy-4-(methylthio)butanoic acid complex in solution;
(b) contacting the complex with activated carbon; and,
(c) removing the activated carbon to yield a purified 2-hydroxy-4-(methylthio)butanoic acid complex.

### DETAILED DESCRIPTION

HMTBA

The usual commercial form of 2-hydroxy-4-methylthiobutanoic acid (HMTBA) is the optically racemic D,L-2-hydroxy-4-methylthiobutanoic acid mixture. It should be understood that while the 2-hydroxy-4-methylthiobutanoic acid compositions referred to hereinafter are racemic mixtures, the individual D- and L-isomers of 2-hydroxy-4-methylthiobutanoic acid can be converted to the 2-hydroxy-4-methylthiobutanoic acid compositions by procedures known in the art. Hence, for purposes of the present invention, the terms “HMTBA” and “2-hydroxy-4-methylthiobutanoic acid” refer either to the D- or L-isomer of 2-hydroxy-4-methylthiobutanoic acid or any mixture of the two above-described isomers thereof. 2-hydroxy-4-methylthiobutanoic acid is available in liquid form (typically 88% minimum by weight) from several commercial sources, including ALIMET™ (Novus International, St. Louis, Mo.) and RHODIMET™ AT 88 (Adisseo, Antony, France). As used herein, “HMTBA” and “2-hydroxy-4-(methylthio)butanoic acid” also refer to any ester or analog thereof.

As used herein, a “2-hydroxy-4-(thiomethyl)-butanoic acid complex,” “HMTBA complex” and “HMTBA-containing complex” refer to a complex containing 2-hydroxy-4-(thiomethyl)-butanoic acid, and include, but are not limited to, a complex between HMTBA and a cation, its salts, chelates, solvates, its esters or analogs, mixtures or combinations thereof. As used herein, a “2-hydroxy-4-(thiomethyl)-butanoic acid complex,” “HMTBA complex” and “HMTBA-containing complex” also refer to 2-hydroxy-4-(thiomethyl)-butanoic acid.

The present invention also contemplates processes for purifying esters of 2-hydroxy-4-(methylthio)butanoic acid, and complexes comprising esters of 2-hydroxy-4-(methylthio)butanoic acid. Representative esters of HMTBA include, for example, methyl, ethyl, n-propyl, isopropyl, butyl esters (including n-butyl, sec-butyl, isobutyl, and tert-butyl), pentyl esters(including n-pentyl and isopentyl), and hexyl esters (including n-hexyl and isohexyl). The esters can be linear or branched chain alkyl esters. The present invention further contemplates the use of diesters of 2-hydroxy-4-(methylthio)butanoic acid, as well as complexes comprising such diesters. Esters of 2-hydroxy-4-(methylthio)butanoic acid can be produced by methods known in the art, for example, from U.S. 2004/0154549, U.S. Pat. No. 4,782,173, and U.S. Pat. No. 4,388,327, which are incorporated herein by reference. Esters of 2-hydroxy-4-(methylthio)butanoic acid can have the advantage that their absorption is more rapid and/or efficient, compared with unesterified 2-hydroxy-4-(methylthio)butanoic acid, thereby increasing their overall bioavailability.

Further contemplated in the present invention is the use of analogs of 2-hydroxy-4-(methylthio)butanoic acid. A number of analogs of 2-hydroxy-4-(methylthio)butanoic acid are known in the art and include, but are not limited to, the analogs disclosed in U.S. Pat. No. 4,782,173, the 2-hydroxy-4-methylsulfinyl-butyric acid and derivatives described within U.S. Pat. No. 3,761,518, the hydroxy acids described in U.S. Pat. No. 5,583,243, which are incorporated herein by reference.

Further contemplated are processes for purifying any alpha-hydroxy acids, including but not limited to lactic acid, and any complexes thereof, using the process of the present invention by addition of activated carbon.

Complexes of HMTBA and its esters and analogs with metal cations can be produced from many available HMTBA preparation, for example the commercially available preparations mentioned above, using processes known in the art. Processes for producing metal cation 2-hydroxy-4-(methylthio)butanoic acid complexes are described, including, for example, in U.S. Pat. No. 2,745,745, U.S. Pat. No. 2,938,053, U.S. Pat. No. 4,579,962, U.S. Pat. No. 4,335,257, U.S. Pat. No. 6,461,664 and U.S. Pat. No. 5,583,243. The 2-hydroxy-4-(methylthio)butanoic acid complex is preferably water soluble, with water solubility at least 0.1% at 25° C., typically at least 0.2%, more typically at least 0.3%, 0.5% or 1.0% in water. In one embodiment, the 2-hydroxy-4-(methylthio)butanoic acid complex comprises an alkali cation and 2-hydroxy-4-(methylthio)butanoic acid. Alternatively, the 2-hydroxy-4-(methylthio)butanoic acid complex can comprise an alkali earth metal or a transition metal. In a preferred embodiment, the cation is calcium. The process described herein can be used to purify 2-hydroxy-4-(methylthio)butanoic acid complexes which comprise mixtures and combinations of different complexes, salts and solvates.

Purification of 2-Hydroxy-4-(Thiomethyl)-Butanoic Acid (HMTBA)-Containing Complexes

Disclosed herein is a process for purifying a 2-hydroxy-4-(methylthio)butanoic acid complex comprising the following steps:
(a) providing a 2-hydroxy-4-(methylthio)butanoic acid complex in solution;
(b) contacting the complex with activated carbon; and,
(c) removing the activated carbon to yield a purified 2-hydroxy-4-(methylthio)butanoic acid complex.

The method described herein relates to the selective removal of contaminants from a composition containing HMTBA or HMTBA-containing complex. The method comprises contacting the composition with activated carbon, whereby the activated carbon selectively binds to the contaminant compared to the HMTBA or HMTBA-containing complex. As used herein, “selective removal” means the relative proportion of contaminant to HMTBA or HMTBA-containing complex is substantially decreased after treatment. In the examples shown, the percent loss of contaminant is substantially greater than the percent loss of HMTBA or HMTBA-containing complex.

In one embodiment, the 2-hydroxy-4-(methylthio)butanoic acid complex comprises a metal cation and 2-hydroxy-4-(methylthio)butanoic acid. The metallic cations can be selected from the group consisting of alkali metals, alkali earth metals and transition metals and other essential cations. In a one embodiment, the cation is selected from the group consisting of sodium, potassium, magnesium, calcium, copper, zinc, iron, chromium, cobalt, molybdenum, selenium or manganese. In one embodiment, the divalent cation is calcium. The process described herein can also be used to purify a mixture of 2-hydroxy-4-(thiomethyl)-butanoic acid complexes in solution (e.g., a mixture of a calcium-2-hydroxy-4-(thiomethyl)-butanoic acid complex and a zinc-2-hydroxy-4-(thiomethyl)-butanoic acid complex).

The 2-hydroxy-4-(methylthio)butanoic acid complex can be contacted with the activated carbon at room temperature, for example at 25° C. Alternatively the temperature can be elevated. In one embodiment, the temperature is at least 40° C. In another embodiment, the temperature is at least 50° C. In another embodiment, the temperature is at least 60° C. The activated carbon can be removed by precipitation, or by filtration. The process can further comprise adding an organic solvent, for example acetone, to the purified complex after step (c) in order to precipitate the complex. Acetone can be added to a concentration of at least 30% (v/v). The 2-hydroxy-4-(methylthio)butanoic acid complex can also be further dried after step (c).

In one embodiment, the 2-hydroxy-4-(methylthio)butanoic acid complex is water soluble. In one embodiment, the 2-hydroxy-4-(thiomethyl)-butanoic acid complex has a solubility of at least 1 g/100 ml (1% w/v) at 25° C., for example, 2%, 3%, 5%, 7%, 10%, 15% or more.

The pH of the 2-hydroxy-4-(thiomethyl)-butanoic acid complex can be adjusted. In one embodiment, the pH of the 2-hydroxy-4-(thiomethyl)-butanoic acid complex is adjusted to a pH between 4 and 11. In another embodiment, the pH of the 2-hydroxy-4-(thiomethyl)-butanoic acid complex is adjusted to between 5 and 10. In yet another embodiment, the pH is adjusted to between 6 and 9. The pH can be adjusted using any base or acid. In one embodiment, the base or acid used for adjustment of pH is not toxic, for example, to an animal, at the final pH of the product. In one embodiment, the pH is adjusted using 2-hydroxy-4-(thiomethyl)-butanoic acid. In another embodiment, the pH is adjusted with a base selected from the group consisting of Ca(OH)₂, Zn(OH)₂, and other hydroxides of metallic cations. It will be appreciated by those skilled in the art that the hydroxides of metallic cations can encompass any degree of hydration thereof.

Activated Carbon/Charcoal

The preferred binding agent in this process, charcoal, is advantageous due to the fact that charcoal does not bind substantial amounts of HMTBA or HMTBA-containing complexes, and because numerous impurities are removed from the crude composition. The 2-hydroxy-4-(methylthio)butanoic acid and 2-hydroxy-4-(methylthio)butanoic acid complexes can be decolorized and purified using absorbents such as, but not limited to, activated carbon, for example ACTICARBONE™ (Ceca, Paris, France), Darco KB and KB-B activated carbon (American Norit Co, Buford, Ga.). The absorbent can simply be mixed with 2-hydroxy-4-(methylthio)butanoic acid or the 2-hydroxy-4-(methylthio)butanoic acid complex in solution at a range of about 1-15 g/L, for example at a range of about 2-10 g/L, 3-8 g/L, or about 5 g/L. Alternatively, the amount of carbon added to the mixture according to the amount of HMTBA present. At least 0.1 g of activated carbon per 100 g of HMTBA can be used, for example at least 0.2 g, 0.5 g, 1.0 g, 2.0 g, 5.0 g or more. In addition, the sample can be stirred with optional heating to at least 30° C., typically at least about 35° C. or at least about 40° C., and preferably at least 45° C. for about 30 min to 24 hrs. The concentration of HMTBA or HMTBA complex in solution is typically between about 1%-50%, for example between 3%-30%, or between 5%-20% (w/v) in solution. The activated carbon can then be removed by precipitation, or by filtration.

Removal/Concentration

After removing the activated carbon, the HMTBA or HMTBA complex can be further purified or concentrated by the addition of a solvent, such as acetone. Acetone can be added to a final concentration of at least 30% (v/v), for example at least 30%, 35%, 40%, 50%, 60%, 70%, 80%, 90%, 95% or at least 99%. Addition of acetone to the 2-hydroxy-4-(methylthio)butanoic acid or 2-hydroxy-4-(methylthio)butanoic acid complex results in lower solubility, hastens precipitation which improves removal of undesirable impurities, and improves the drying properties of the precipitated complex. The precipitate can then be collected and dried, for example by lyophilization.

Alternatively, the HMTBA or HMTBA complex can be further purified by crystallization Crystals can be formed by causing precipitation to occur more slowly, for example, slower addition of acetone.

Measuring Purity of HMTBA or HMTBA Complexes

Purity of the HMTBA or HMTBA containing complexes can be measured using many means known in the art, for example, by spectrophotometry, for example at a wavelength of 430 nm to detect colored impurities. The absorbance at 430 nm of a 1% [w/v] solution of HMTBA or HMTBA complex purified using the methods of the present invention is typically no more than 0.01, for example no more than 0.008. Purity of HMTBA can also be measured by oxidation of the sulfur by bromine in acid medium and titration by potentiometry as described in Siggla and Edsberg (Ind. Eng. Chem. Anal. Ed., 1948, 20:938-939) method for diakyl sulfides. Alternatively, purity can be measured using HPLC, mass spectroscopy, or any other means known in the art.

The following examples demonstrate experiments performed and contemplated by the present inventors in making and carrying out the invention. It is believed that these examples include a disclosure of techniques which serve to both apprise the art of the practice of the invention and to demonstrate its usefulness. It will be appreciated by those of skill in the art that the techniques and embodiments disclosed herein are preferred and non-limiting embodiments only, and that in general numerous equivalent methods and techniques may be employed to achieve the same result.

### EXAMPLES

### Example 1

### Purification of HMTBA

A series of experiments were set up to evaluate the use of carbon, recrystallization, and a novel approach to precipitation of the HMTBA after color removal. Previous experiments to remove discoloration were done by washing powdered HMTBA with selected solvents including acetone, methyl isobutyl ketone, and tetrahydrofuran. Recrystalization from water provided the greatest improvement followed by an acetone rinse to remove additional color and water.

Experiments to evaluate the potential for color removal by extraction of color causing contaminants were done by mixing overnight suspensions of HMTBA in various solvents in the ratio of:

10 g of MHA with 50 g of acetone

6 g of MHA with 50 ml of methyl isobutyl ketone (MIBK):

3.14 g of HMTBA with 6.4 g of tetrahydrofuran.

The recrystalized HMTBA sample was generated by dissolving 6 g of HMTBA in 105 ml of water and than adding 100 ml of acetone to precipitate out the purified HMTBA. For the untreated control, a 5% solution of HMTBA (ALIMET, Novus International, St. Louis, Mo.) was prepared by dissolving 20 g of HMTBA in 400 g water. After approximately 2 hours, sample was filtered to yield a yellowish solution. The absorbance values of the HMTBA solutions after various treatments are indicated in Table I.

TABLE I

| | Absorbance_{430 nm} |
|---|---|
| Treatment | (0.1 g/10 mL) |
| Untreated | 0.0122 |
| Tetrahydrofuran (THF) | 0.0106 |
| Methylisobutylketone (MIBK) | 0.0084 |
| Acetone | 0.0091 |
| Recrystalized from water | 0.0052 |

### Example 2

### Simplified Procedure for the Purification of HMTBA

400 g of a 5% solution HMTBA, prepared as described above, was mixed with 2 g ACTICARBONE™ ENO powdered activated carbon (Ceca, Paris, France) and allowed to stir for 2 hours. The sample was then filtered to yield a colorless clear solution. 200 ml of the resulting filtrate was transferred to a jar and mixed with 250 ml of acetone. After approximately 2 hours, the sample was filtered, yielding a white product. Recovery was determined to be 67%

### Example 3

### Purification of HMTBA Complexes I

Calcium-HMTBA was prepared by adding 4.42 g Ca(OH)₂ to 400 ml of a 5% solution of HMTBA, prepared as described above. The resulting solution was filtered approximately 15 minutes after mixing, yielding a brownish clear liquid.

To the Calcium-HMTBA solution prepared as described above, 2 g ACTICARBONE™ ENO powdered activated carbon was added. The mixture was stirred for approximately 15 minutes before filtration, yielding a colorless clear liquid. 200 ml of the filtrate was transferred to ajar and mixed with 250 ml of acetone to precipitate the Calcium-HMTBA complex. Approximately two hours after adding the acetone, the mixture was again filtered, yielding a white product.

A more concentrated solution of Calcium-HMTBA was prepared by addition of 8.8 g Ca(OH)₂ to 400 ml of a 10% solution of HMTBA. Approximately 15 minutes after addition of Ca(OH)₂, the resulting solution was filtered, yielding a yellowish clear liquid. 1 g ACTICARBONE™ ENO powdered activated carbon was added to the filtrate and mixed for 5 minutes before a second filtration step. The resulting filtrate was a nearly colorless clear liquid. Calcium-HMTBA was precipitated from the filtrate by acetone addition, and the precipitate was collected by vacuum filtration and dried on lyophilizer to yield a white product.

In another experiment, activated charcoal was added directly at the time of Calcium-HMTBA preparation. 2 g ACTICARBONE™ ENO powdered activated carbon was mixed simultaneously with 40.39 g ALIMET, 400 ml DI water, and 8.92 g Ca(OH)₂, and filtered approximately 30 minutes after mixing to yield a colorless clear liquid. Samples were all allowed to stand at room temperature and in all cases the samples were allowed to stand quiescent without stirring. Thirty minutes after filtration, significant precipitation was apparent, and after three hours the solution had become a slurry. The sample was filtered after three hours, and collected precipitate was further dried in lyophilizer. The resulting product was extraordinarily bright white.

### Example 4

### Method for Preparation of HMTBA Complex II

The following method was also used for the purification of HMTBA complex. In this example, a Calcium-HMTBA complex was formed after purification of the 2-hydroxy-4-(thiomethyl)-butanoic acid free acid.

Neutralized HMTBA was prepared as follows. 100 g of HMTBA (88%) was mixed with 300 g of deionized water (DI) to yield a diluted HMTBA solution. Approximately 44 g of 50% solution of sodium hydroxide (NaOH in water) was then added to the HMTBA solution while stirring, adjusting the pH to approximately 9.0. Granular charcoal was added and allowed to stir at room temperature overnight. The solution was then filtered through a 0.2 micron micron filter, yielding a purified HMTBA solution. 100 g of purified HMTBA solution was transferred to a vessel, and mixed with 1.74 g of a 10% (w/w) CaCl₂ solution in ethanol, which was added while stirring over a 30 minute period at room temperature. The mixture was stirred for an additional 5 hours at room temperature. The mixture was filtered through filter paper (Whatman #1), and filtered solution was dried at 80° C. under partial vacuum and was nitrogen purged overnight, yielding the purified HMTBA₂ Ca (19.03 g) product. Yield was 84%. Purity of the recovered purified HMTBA₂ Ca is shown in Table 2.

TABLE II

| Purity | 99% by titration |
|---|---|
| LOD | 0.5% |
| Acetone | 0.4 ppm |
| MIBK | trace |
| Calcium | 11.8% |
| pH | 6.71 |
| Chloride | <200 ppm |
| Sieve size | 97% retained on 400 mesh |
| | screen and |
| 0% retained on | |
| 80 mesh screen | |
| Color | 0.0015 absorbance at 430 nm |
| | for a 1% solution |
| Bulk density | 0.645 g/cc |
| Calcium sulfate | 1.1% |

1. A process for purifying a 2-hydroxy-4-(thiomethyl)-butanoic acid complex comprising:
(a) contacting a 2-hydroxy-4-(thiomethyl)-butanoic acid complex with activated carbon; and
(b) removing said activated carbon to yield a purified 2-hydroxy-4-(thiomethyl)-butanoic acid complex.

2. The process of claim 1, wherein said 2-hydroxy-4-(thiomethyl)-butanoic acid complex is in solution during steps (a) and (b).

3. The process of claim 2, further comprising, after step (b):
(c) drying said purified 2-hydroxy-4-(thiomethyl)-butanoic acid complex.

4. The process of claim 2, further comprising, after step (b):
(c) adding acetone to the solution to precipitate said purified 2-hydroxy-4-(thiomethyl)-butanoic acid complex.

5. The process of claim 4, wherein said acetone is added to a concentration of at least 30% (v/v).

6. The process of claim 4, wherein said purified 2-hydroxy-4-(thiomethyl)-butanoic acid complex forms crystals.

7. The process of claim 2, wherein said activated carbon is removed by precipitation.

8. The process of claim 2, wherein said activated carbon is removed by filtration.

9. The process of claim 2, wherein said 2-hydroxy-4-(thiomethyl)-butanoic acid complex comprises a metal cation.

10. The process of claim 9, wherein said metal cation is a divalent cation.

11. The process of claim 10, wherein said divalent metal cation is selected from the group consisting of calcium and zinc.

12. The process of claim 2, wherein said 2-hydroxy-4-(thiomethyl)-butanoic acid complex is in solution during step (a) at a concentration of about 0.1% (wt/vol) to about 15% (wt/vol).

13. The process of claim 12, wherein said 2-hydroxy-4-(thiomethyl)-butanoic acid complex is present at a concentration of about 5% (wt/vol) or about 10% (wt/vol).

14. The process of claim 2, wherein said activated charcoal is added to a concentration of about 1 g/L to about 15 g/L.

15. The process of claim 2, wherein during step (a) the the mixture of 2-hydroxy-4-(thiomethyl)-butanoic acid complex and activated charcoal is heated to a temperature in the range from about 25° C. to about 60° C.

16. The process of claim 2, wherein the solution has a pH in the range from about 4 to about 11.

17. The process of claim 2, wherein a solution comprising 1% (w/v) of said purified 2-hydroxy-4-(thiomethyl)-butanoic acid complex has at absorbance at 430 nm of no more than 0.01.

18. A 2-hydroxy-4-(thiomethyl)-butanoic acid complex made by the process of claim 1.

19. The 2-hydroxy-4-(thiomethyl)-butanoic acid complex of claim 18 comprising calcium or zinc.

20. The 2-hydroxy-4-(thiomethyl)-butanoic acid complex of claim 18, wherein a solution comprising said complex at 1% (w/v) has an absorbance at 430 nm of no more than 0.01.
